(19) United States
(12) Patent Application Publication
(10) Pub. No.: US 2022/0274479 A1
(43) Pub. Date: Sep. 1, 2022

(54) Power Shiftable Hybrid Transmission, Drivetrain and Motor Vehicle

(71) Applicant: ZF Friedrichshafen AG, Friedrichshafen (DE)

(72) Inventors: Stefan Beck, Eriskirch (DE); Johannes Kaltenbach, Friedrichshafen (DE); Fabian Kutter, Kressbronn (DE); Matthias Horn, Tettnang (DE); Thomas Martin, Weissensberg (DE); Michael Wechs, Weißensberg (DE); Oliver Bayer, Hörbranz (AT); Thomas Kroh, Lindau (DE); Peter Ziemer, Tettnang (DE); Martin Brehmer, Tettnang (DE); Max Bachmann, Friedrichshafen (DE)

(21) Appl. No.: 17/624,693

(22) PCT Filed: Jun. 2, 2020
(86) PCT No.: PCT/EP2020/065131

§ 371 Date: Jan. 4, 2022

(30) Foreign Application Priority Data
Jul. 5, 2019 (DE) 10 2019 209 931.9

(51) Int. Cl. B60K 6/547; B60K 6/387; B60K 6/442; F16H 3/089

(52) U.S. Cl. CPC B60K 6/547; B60K 6/387; B60K 6/442; F16H 3/089; B60K 2006/4825

(57) ABSTRACT

A hybrid transmission (20) for a motor vehicle drive train (12) with an internal combustion engine (14), a first electric prime mover (16), and a second electric prime mover (18), includes: a first transmission input shaft (24) for a first sub-transmission coaxially drivingly connectable to the internal combustion engine and/or drivingly connectable to the second electric prime mover in an axially parallel manner; a second transmission input shaft (26) for a second sub-transmission drivingly connectable to the first electric prime mover in an axially parallel manner; a countershaft (28); idler gears and fixed gears arranged in multiple gear set planes for forming gear steps; and multiple gear change devices including shift elements (A-E) for engaging the gear steps. All even gear steps are associated with one sub-transmission and all odd gear steps are associated with the other sub-transmission such that all electric-machine gear steps are power shiftable.

### CROSS-REFERENCE TO RELATED APPLICATIONS

The present application is related and has right of priority to German Patent Application No. 102019209931.9 filed in the German Patent Office on Jul. 5, 2019 and is a national phase of PCT/EP2020/065131 filed in the European Patent Office on Jun. 2, 2020, both of which are incorporated by reference in their entirety for all purposes.

### FIELD OF THE INVENTION

The present invention relates generally to a hybrid transmission for a motor vehicle drive train, a motor vehicle drive train with a hybrid transmission of this type, and to a motor vehicle with a motor vehicle drive train of this type.

### BACKGROUND

Vehicles are increasingly equipped with hybrid drives, i.e., with at least two different drive sources. Hybrid drives can contribute to the reduction of fuel consumption and pollutant emissions. Drive trains having an internal combustion engine and one or multiple electric motors have largely prevailed as a parallel hybrid or as a mixed hybrid. These types of hybrid drives have an essentially parallel arrangement of the internal combustion engine and the electric drive in the power flow. A superposition of the drive torques as well as a control with a purely internal combustion engine-generated drive or a purely electric motor-generated drive is made possible. Since the drive torques of the electric drive and of the internal combustion engine can add up, depending on the actuation, a comparatively smaller design of the internal combustion engine and/or intermittent shut-down of the internal combustion engine are/is possible. As a result, a significant reduction of the carbon dioxide (CO2) emissions can be achieved without significant losses of power and/or comfort. The possibilities and advantages of an electric drive can therefore be combined with the range, power, and cost advantages of internal combustion engines.

One disadvantage of the aforementioned hybrid drives consists of a generally more complex configuration, since both drive sources preferably transmit input power onto an input shaft with only one hybrid transmission. Moreover, individual gear steps can be partially achieved without an interruption of tractive force for only one drive source. A reduction of the complexity of the configuration of a hybrid transmission is usually associated with a loss of variability.

Publication DE 10 2011 005 451 A1 describes a hybrid drive of a motor vehicle, which includes an automated manual transmission having two input shafts and a shared output shaft. The first input shaft is connectable to the drive shaft of an internal combustion engine via a separating clutch and is bringable into a drive connection with the output shaft via a first group of selectively engageable gear-step gear sets. The second input shaft is drivingly connected to the rotor of an electric machine, which is operable as a motor and as a generator, and is bringable into a drive connection with the output shaft via a second group of selectively engageable gear-step gear sets. The input shafts are coupleable to each other via an engageable and disengageable coupling shift element. In order to improve the operating properties of the hybrid drive, a second electric machine operable as a motor and as a generator is provided, the rotor of which is drivingly connected to the first input shaft.

### SUMMARY OF THE INVENTION

Example aspects of the present invention provide a power shiftable hybrid transmission, with which purely electric powershifts are possible. In particular, a power shiftable hybrid transmission and a motor vehicle drive train having high variability are provided, which are technically simply designed.

A hybrid transmission for a motor vehicle having an internal combustion engine, a first electric prime mover, and a second electric prime mover, includes:

a first transmission input shaft for a first sub-transmission, which is coaxially drivingly connectable to the internal combustion engine and/or drivingly connectable to the second electric prime mover in an axially parallel manner;

a second transmission input shaft for a second sub-transmission, which is drivingly connectable to the first electric prime mover in an axially parallel manner;

a countershaft;

idler gears and fixed gears arranged in multiple gear set planes for forming gear steps; and

multiple gear change devices including shift elements for engaging the gear steps,

wherein all even gear steps are associated with the first sub-transmission or the second sub-transmission and all odd gear steps are associated with the particular other sub-transmission.

A motor vehicle drive train for a motor vehicle, includes:

a hybrid transmission as described above;

an internal combustion engine, which is connectable to the first transmission input shaft;

a first electric prime mover, which is connectable to the second transmission input shaft; and

a second electric prime mover, which is connectable to the first transmission input shaft.

A motor vehicle includes:

a motor vehicle drive train as described above; and

an energy accumulator for storing energy for supplying the first electric prime mover and/or the second electric prime mover.

It is understood that the features, which are mentioned above and which will be described in greater detail in the following, are usable not only in the particular combination indicated, but rather also in other combinations or alone, without departing from the scope of the present invention.

Due to the assignment of all even gear steps to one sub-transmission and all odd gear steps to the other sub-transmission, a hybrid transmission can be created, with which all electric-machine gear steps are power shiftable. Due to the utilization of a countershaft, the hybrid transmission can be designed to be compact. Moreover, comparatively few meshing points arise, and so a good gearing efficiency can be achieved. A hybrid transmission having a simple configuration can be created, which is preferably suitable for a front-mounted transverse arrangement or a rear-mounted transverse arrangement in a motor vehicle.

According to one advantageous example embodiment, the hybrid transmission includes a connecting clutch having a shift element in order to drivingly connect the first sub-transmission and the second sub-transmission. As a result, a range of functions of the hybrid transmission can be expanded in a technically easy way. In particular, by engaging the connecting clutch, all gear steps of the hybrid transmission can also be engaged for the internal combustion engine in a technically easy way.

In one advantageous example embodiment, the hybrid transmission includes an internal combustion engine clutch in order to detachably drivingly connect the internal combustion engine to the first transmission input shaft. As a result, all gear steps of the hybrid transmission can be utilized in a purely electric operation. In particular, the internal combustion engine can be decoupled from the hybrid transmission, and so the internal combustion engine does not need to be entrained. The hybrid transmission can be efficiently operated.

In one advantageous example embodiment, the internal combustion engine clutch is designed as a friction clutch or as a form-locking shift element. As a result, the internal combustion engine clutch can also be disengaged under load, in particular during a full brake application or a malfunction of the internal combustion engine. The internal combustion engine clutch can be engaged at a differential speed, and so a “flywheel start” of the internal combustion engine is possible by the first electric prime mover and/or the second electric prime mover. A “drag start” of the internal combustion engine is also possible, in which the internal combustion engine is started via the slipping internal combustion engine clutch. Due to the utilization of an internal combustion engine clutch that is designed as a form-locking shift element, a loss in the coupling can be reduced. Moreover, a lower heat input and, thereby, a simpler cooling of the internal combustion engine clutch are possible. Due to the provision of a form-locking shift element, the installation space requirement of the hybrid transmission can be reduced. Preferably, the form-locking shift element is designed in the form of a dog clutch.

In one advantageous example embodiment, at least two of the shift elements are designed as a double shift element and are actuatable by a double-acting actuator. As a result, the open-loop control can be simplified. Moreover, an installation space requirement of the hybrid transmission can be further reduced. As a result, the hybrid transmission is technically simple.

In one advantageous example embodiment, the first transmission input shaft and the second transmission input shaft are arranged coaxially to each other. One of the transmission input shafts is designed as a hollow shaft and encompasses the other transmission input shaft, at least partially or in sections. As a result, a hybrid transmission can be created that is compact.

In one advantageous example embodiment, a gear-forming fixed gear of the first sub-transmission can be designed for being operatively connected to the second electric prime mover. Additionally or alternatively, a gear-forming fixed gear of the second sub-transmission is designed for being drivingly operatively connected to the first electric prime mover. As a result, a connection of the electric machines can take place in a simplified manner. In particular, no further gearwheels and/or transmission components are necessary. The hybrid transmission is compact. Moreover, an axially parallel connection of the electric prime movers can take place, and so the hybrid transmission is, in particular, axially short.

In one advantageous example embodiment, the gear-forming gearwheel is the gearwheel of the highest gear step of the sub-transmission in each case. In this way, a high reduction ratio for the first electric prime mover and/or the second electric prime mover can preferably be achieved without a further gear stage. The hybrid transmission is more lightweight and less complicated, since fewer components are utilized. The electric prime movers can be operated in a highly efficient speed range.

In one advantageous example embodiment, a gear-forming fixed gear arranged at a first axial end of the hybrid transmission is designed for being drivingly connected to the first electric prime mover and/or the second electric prime mover. As a result, an application of force into the hybrid transmission can be advantageously supported, since a fixed gear arranged at one axial end has only a small distance to a possible mounting of a transmission shaft. Moreover, as a result, sufficient installation space can be created for a large electric prime mover without increasing the axial installation length of the transmission.

In one advantageous example embodiment, a gear-forming fixed gear arranged at a second axial end of the hybrid transmission opposite the first axial end is designed for being drivingly connected to the first electric prime mover and/or the second electric prime mover. As a result, both electric prime movers can be advantageously connected to the hybrid transmission. In particular, a hybrid transmission can be created, which can be utilized with two electric prime movers without increasing the axial installation length of the hybrid transmission.

In one preferred example embodiment, the first electric prime mover and/or the second electric prime mover are/is actuatable as a starter generator for starting the internal combustion engine. Additionally or alternatively, the first electric prime mover and/or the second electric prime mover are/is actuatable as a charging generator for charging an energy accumulator. Moreover, additionally or alternatively, the first electric prime mover and/or the second electric prime mover are/is actuatable as a generator for supplying the first or second electric prime mover in a serial traveling mode. In this way, the hybrid transmission can be efficiently operated. For example, a stationary charging is possible. The fuel consumption can be reduced. Moreover, an additional starter for the internal combustion engine can be omitted.

In one preferred example embodiment, the second electric prime mover and/or the internal combustion engine are/is actuatable, at least partially, as a supporting force mechanism during gear changes of the first electric prime mover. Additionally or alternatively, the first electric prime mover is actuatable, at least partially, as a supporting force mechanism during gear changes of the second electric prime mover and/or of the internal combustion engine. As a result, a comfortable change of the gear stages is made possible. Moreover, the hybrid transmission has lower wear and a higher stability against failure.

In one advantageous example embodiment, the first electric prime mover and/or the second electric prime mover are/is arranged axially parallel to the first transmission input shaft and/or the second transmission input shaft. A connection of the electric prime mover to the hybrid transmission is technically easily possible in this case. Moreover, due to the advantageous arrangement, the available installation space can be utilized in order to use correspondingly large electric prime movers. The motor vehicle drive train can be designed to be compact and powerful.

In particular, a vibration damping can be provided for a drive under internal combustion engine power. For example, a crankshaft of the internal combustion engine can be connected to a flywheel. Moreover, the internal combustion engine can be connected to an interconnected vibration damper with the internal combustion engine input shaft provided for the connection to the internal combustion engine. In addition, the internal combustion engine can be connected to an interconnected vibration damper with the engine-side clutch shaft of a clutch provided for the connection to the internal combustion engine.

Moreover, a safety slipping clutch can be provided. The internal combustion engine can be connected to the hybrid transmission with an interconnected safety clutch. A clutch of this type limits the transmissible torque and, in this way, can protect the transmission mechanics against overload. The clutch is passive, i.e., the clutch does not need active control. Likewise, an electric prime mover connected to the hybrid transmission can be connected to the hybrid transmission via a safety clutch.

Stationary charging is understood, in particular, to be the operation of the electric prime mover as a generator, preferably while the vehicle is at rest with the internal combustion engine running, in order to charge an energy accumulator and/or to supply onboard electronics.

An actuator in the present case is, in particular, a component that converts an electrical signal into a mechanical motion. Preferably, actuators that are utilized with double shift elements carry out movements in two opposite directions in order to engage one shift element of the double shift element in the first direction and to engage the other shift element in the second direction.

A gear step change takes place, in particular, by disengaging one shift element and/or a clutch and simultaneously engaging the shift element and/or the clutch for the next higher or lower gear step. The second shift element and/or the second clutch therefore gradually take(s) on the torque from the first shift element and/or the first clutch until, by the end of the gear step change, the entire torque has been taken on by the second shift element and/or the second clutch.

An internal combustion engine can be, in particular, any machine that can generate a turning motion by burning a fuel, such as gasoline fuel, diesel fuel, kerosene, ethanol, liquefied gas, liquefied petroleum gas, etc. An internal combustion engine can be, for example, a spark-ignition engine, a diesel engine, a Wankel rotary piston Engine®, or a two-stroke engine.

Entraining the internal combustion engine into motion is understood to mean starting the internal combustion engine or setting the internal combustion engine into rotation. The entrainment into motion takes place by at least partially engaging a friction clutch with a gear step engaged and the ignition switched on, wherein the “momentum” of a vehicle in motion, i.e., the kinetic energy, is transmitted by the power train to the internal combustion engine.

A serial driving operation is to be understood to be an operating mode, in which the internal combustion engine acts as a drive for an electric prime mover operated as a generator, which supplies a further electric prime mover, and so the internal combustion engine is decoupled from the driving wheels and, preferably, can be operated continuously at a single, low-emission operating point.

### BRIEF DESCRIPTION OF THE DRAWINGS

Example aspects of the invention are described and explained in greater detail in the following with reference to a few selected exemplary embodiments in conjunction with the attached drawings, in which:

FIG. 1 shows a schematic of a motor vehicle with a motor vehicle drive train according to example aspects of the invention;

FIG. 2 shows a schematic of a hybrid transmission according to example aspects of the invention;

FIG. 3 shows a schematic of a gear shift matrix of the hybrid transmission according to example aspects of the invention from FIG. 2;

FIG. 4 shows a second variant of a hybrid transmission according to example aspects of the invention;

FIG. 5 shows a third variant of a hybrid transmission according to example aspects of the invention; and

FIG. 6 shows a fourth variant of a hybrid transmission according to example aspects of the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

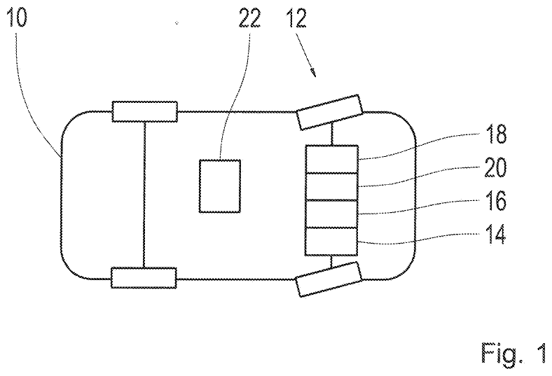

FIG. 1 diagrammatically shows a motor vehicle 10 having a motor vehicle drive train 12. The motor vehicle drive train 12 includes an internal combustion engine 14, a first electric prime mover 16, and a second electric prime mover 18, which are connected by a hybrid transmission 20 to a front axle of the motor vehicle 10. Drive power of the electric prime movers 16, 18 and the internal combustion engine 14 is supplied to the wheels of the motor vehicle 10 by the motor vehicle drive train 12. The motor vehicle 10 also includes an energy accumulator 22 in order to store energy, which is utilized for supplying the first electric prime mover 16 and/or the second electric prime mover 18.

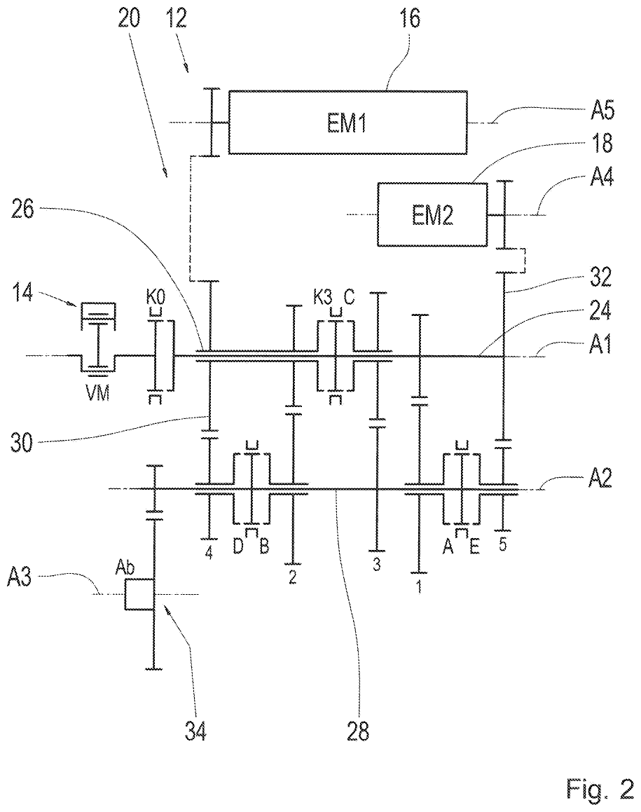

A first example variant of a hybrid transmission 20 is shown in FIG. 2. The hybrid transmission 20 includes a first transmission input shaft 24, which is designed as a solid shaft in this example. The hybrid transmission 20 also includes a second transmission input shaft 26, which is designed as a hollow shaft and surrounds the first transmission input shaft 24, at least partially or in sections. A countershaft 28 is arranged axially parallel to the first transmission input shaft 24 and to the second transmission input shaft 26. The internal combustion engine 14 is connectable to the first transmission input shaft 24 by an internal combustion engine clutch K0 and is arranged coaxially to the first transmission input shaft 24. The first transmission input shaft 24 supplies drive power to a first sub-transmission of the hybrid transmission 20, which includes the odd gear steps of the hybrid transmission 20. The second transmission input shaft 26 supplies drive power to a second sub-transmission of the hybrid transmission 20, which includes the even gear steps of the hybrid transmission 20.

The hybrid transmission 20 includes five gear steps, each of which is formed by one gearwheel pair made up of an idler gear and a fixed gear. The first electric prime mover 16 is connected to the hybrid transmission 20 via a fixed gear 30 of the fourth gear step. The second electric prime mover 18 is connected to the hybrid transmission 20 via a fixed gear 32 of the fifth gear step. The fixed gears of the second and fourth gear steps are arranged on the second transmission input shaft 26. The fixed gears of the first and fifth gear steps are arranged on the first transmission input shaft 24. The third gear step is formed by a fixed gear, which is arranged at the countershaft 28, and an idler gear, which is arranged at the first transmission input shaft 24. The countershaft 28 is drivingly connected to a drive output 34 via a gearwheel pair made up of fixed gears. The drive output 34 transmits the drive power supplied to the hybrid transmission 20 onto an axle and/or driven wheels of the motor vehicle 10 (not shown).

The shift element A is arranged on the countershaft 28 and is associated with the first gear step. The shift element B is arranged on the countershaft 28 and is associated with the second gear step. The shift element C is arranged on the first transmission input shaft 24 and is associated with the third gear step. The shift element D is associated with the fourth gear step and is arranged on the countershaft 28. The shift element E is associated with the fifth gear step and is arranged on the countershaft 28. The shift elements A and E form a double shift element. The shift elements D and B form a double shift element. The shift element C forms a double shift element together with a shift element K3 of a connecting clutch. By engaging the shift element K3, the first transmission input shaft 24 can be rotationally fixed to the second transmission input shaft 26.

The internal combustion engine 14 and the first transmission input shaft 24 and the second transmission input shaft 26 are arranged on a transmission axis A1. The countershaft is arranged on a transmission axis A2. The second electric prime mover 18 is arranged on a transmission axis A4. The first electric prime mover 16 is arranged on a transmission axis A5.

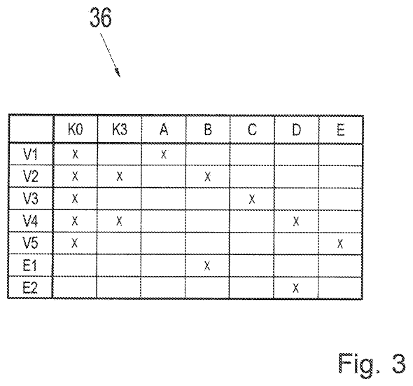

FIG. 3 shows a gear shift matrix 36 of the hybrid transmission 20 from FIG. 2 and the following embodiments of hybrid transmissions 20. The first column lists the internal-combustion-engine gear steps V1 through V5 of the internal combustion engine 14 and the electric-machine gear steps E1 and E2 of the first electric prime mover 16. The gear shift matrix 36 indicates which gear steps 1 through 5 of the hybrid transmission 20 correspond to which of the internal-combustion-engine gear steps V1 through V5 and to which of the electric-machine gear steps E1 and E2.

The second to eighth columns show the engagement conditions of the internal combustion engine clutch K0 and the individual shift elements K3 and A through E, wherein an “X” indicates that the shift element and/or the internal combustion engine clutch K0 are/is engaged, i.e., drivingly connect the associated components.

For the internal-combustion-engine gear step V1, the internal combustion engine clutch K0 and the shift element A are to be engaged. For the internal-combustion-engine gear step V2, the internal combustion engine clutch K0 and the shift element K3 of the connecting clutch as well as the shift element B are to be engaged. For the internal-combustion-engine gear step V3, the internal combustion engine clutch K0 and the shift element C are to be engaged. For the internal-combustion-engine gear step V4, the internal combustion engine clutch K0, the shift element K3 of the connecting clutch as well as the shift element D are to be engaged. For the internal-combustion-engine gear step V5, the internal combustion engine clutch K0 and the shift element E are to be engaged. For the electric-machine gear step E1 of the first electric prime mover 16, the shift element B is to be engaged. For the electric-machine gear step E2 of the first electric prime mover 16, the shift element D is to be engaged.

Further electric-machine gear steps of the second electric prime mover 18 can also be established with the hybrid transmission 20. These engage similarly to the internal-combustion-engine gear steps V1 through V5, although the internal combustion engine clutch K0 is to be disengaged for the purely electric operation.

It is also understood that the gear steps of the internal combustion engine 14 and of the first and second electric prime movers 16, 18 can be utilized in combination in a hybrid mode for driving.

Therefore, driving can be carried out with both electric prime movers 16, 18 in a purely electric operation. Powershifts are possible in this purely electric operation, in that the first electric prime mover 16 supports the tractive force when a gear step change takes place for the second electric prime mover 18, and the second electric prime mover 18 supports the tractive force when a gear step change takes place for the first electric prime mover 16.

In the internal combustion engine-driven mode, therefore, the internal combustion engine clutch K0 always remains engaged. As a result, the internal combustion engine 14 is preferably always connected to the second electric prime mover 18 in the internal combustion engine-driven mode.

The following functions can be covered by the second electric prime mover 18. A start of the internal combustion engine 14 while driving under purely electric motor power is possible. The second electric prime mover 18 can be driven as a generator by the internal combustion engine 14 and ensure a supply of the main power circuit and of the onboard electronics. A serial creeping and driving forward/in reverse is possible. Here, the energy made available by the second electric prime mover 18 while acting as a generator is provided to the first electric prime mover 16 and driving takes place by the first electric prime mover 16. A support of a closed-loop control of the rotational speed of the internal combustion engine 14 can take place during coupling and during gear shifts. For example, the internal combustion engine 14 can be coupled into the gears 1, 2, 3, and 5 of the hybrid transmission 20 when the first electric prime mover 16 utilizes the gear step E1. The internal combustion engine 14 can be coupled into the gears 1, 3, 4, and 5 of the hybrid transmission 20 when the first electric prime mover 16 utilizes the gear step E2.

The second electric prime mover 18 can provide support during the unloading of the shift elements K3, A, C, and E, in that the second electric prime mover 18 operates as a generator. The generated energy can be utilized by the first electric prime mover 16 for supporting tractive force.

The following functions, in particular, can be covered by the first electric prime mover 16. An electric vehicle drive can be established for pulling away from rest and driving forward/in reverse. A support of the tractive force during gear shifts of the internal combustion engine 14 is possible. The first electric prime mover 16 can maintain the tractive force when a change takes place with the shift elements K3, A, C, E. The first electric prime mover 16 can be drivingly connected to the internal combustion engine 14 via the shift element K3 of the connecting clutch. For this purpose, additionally, the internal combustion engine clutch K0 is to be engaged. In this shift condition, the first electric prime mover 16 can start the internal combustion engine 14 or be utilized as a generator for generating power for a consumer, for example, when the vehicle is at a standstill.

A powershift from the first internal-combustion-engine gear V1 into the second internal-combustion-engine gear V2 in the hybrid mode can take place as follows. The starting point is the internal-combustion-engine gear step V1, in which the internal combustion engine clutch K0 and the shift element A are engaged. A load reduction takes place at the shift element A and a simultaneous load build-up takes place at the first electric prime mover 16. The load reduction can take place in that the internal combustion engine 14 and the second electric prime mover 18 reduce the torque or when the second electric prime mover compensates for the torque of the internal combustion engine 14 while acting as a generator, and so the sum of the torques from the internal combustion engine 14 and the second electric prime mover 18 is essentially zero. The shift element A is disengaged. The rotational speed of the internal combustion engine 14 and of the second electric prime mover 18 is reduced, and so the shift element K3 of the connecting clutch is synchronized. For this purpose, for example, the second electric prime mover 18 can operate as a generator, which is preferred, or the internal combustion engine 14 can enter the coasting condition. The shift element K3 can be engaged.

A reduction of the rotational speed of the first electric prime mover 16 in the hybrid mode can take place as follows. When the shift element K3 of the connecting clutch is disengaged, a change from the first electric-machine gear step E1 into the second electric-machine gear step E2 can take place in the background without load. As a result, the rotational speed of the first electric prime mover 16 is reduced. This shifting process takes place while the internal combustion engine 14 and/or the second electric prime mover 18 maintain(s) the tractive force in one of the gear steps 1, 3, 5 of the hybrid transmission 20.

In the hybrid mode, the first electric prime mover 16 can be decoupled when the internal combustion engine 14 utilizes one of the gear steps 1, 3, 5 of the hybrid transmission 20. In this way, an efficient internal combustion engine-driven operation is possible.

Preferably, the second electric prime mover 18 can be dimensioned smaller than the first electric prime mover 16, since the second electric prime mover does not need to perform essential driving functions. The first electric prime mover 16 is utilized as a main prime mover.

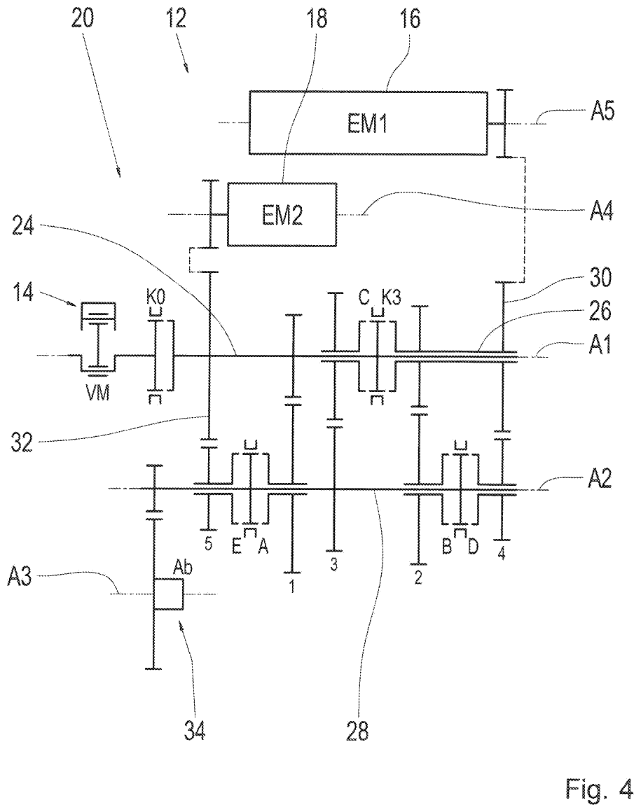

FIGS. 4 through 6 show further variants of hybrid transmissions 20 according to example aspects of the invention. Identical reference characters refer to identical features and are not explained once again. Only the differences are to be discussed in the following.

FIG. 4 shows a second example variant of a hybrid transmission 20. The first sub-transmission and the second sub-transmission are designed as a mirror image practically at a center of the hybrid transmission 20. The gear steps 1, 3, and 5, i.e., the odd gear steps of the hybrid transmission 20, are arranged on the first sub-transmission. The gear steps 2 and 4 are arranged on the second sub-transmission. The first and second electric prime movers 16, 18 are each connected to a sub-transmission, wherein the first electric prime mover 16, which is preferably utilized as a main prime mover, is operatively connected to the second sub-transmission, i.e., the transmission that includes the even gear steps. The first and second electric prime movers 16, 18 are connected axially in parallel and are each connected to the gearwheel of the highest gear step of the particular sub-transmission, wherein this gearwheel is designed as a fixed gear in each case. In the example shown in FIG. 4, the gear sequence from the left, i.e., as viewed from the connection point of the internal combustion engine 14, is: 5, 1, 3, 2, and 4.

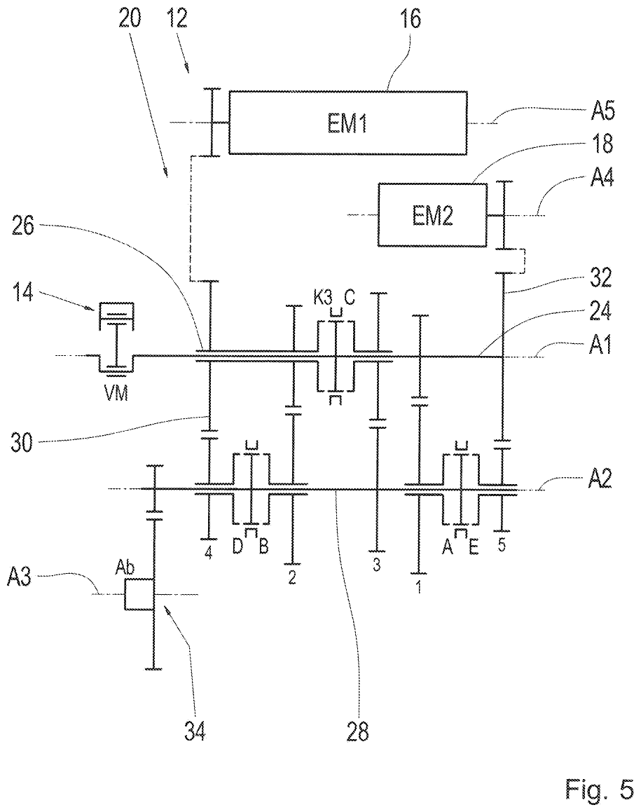

In FIG. 5, a third example variant of a hybrid transmission 20 is shown, in which, in contrast to the example variant shown in FIG. 2, the internal combustion engine clutch K0 has been omitted. As a result, the hybrid transmission 20 can be designed having fewer components and, in particular, having fewer actuators. The open-loop control of the hybrid transmission 20 is simplified. It is understood that, in the case of this type of hybrid transmission 20, pulling away from rest preferably takes place by the first electric prime mover 16.

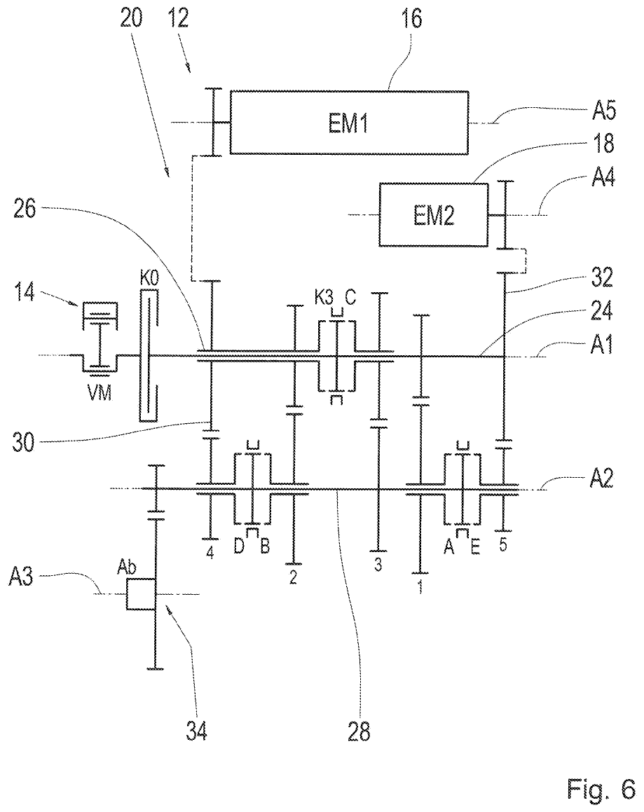

FIG. 6 shows one further fourth example variant of a hybrid transmission 20, in which the internal combustion engine clutch K0 is designed as a friction clutch. As a result, the internal combustion engine clutch K0 can also be disengaged under load. For example, during a full brake application or a malfunction of the internal combustion engine 14, the internal combustion engine clutch K0 can be disengaged immediately. In particular, the internal combustion engine clutch K0 can also be engaged at a differential speed. As a result, a “flywheel start” of the internal combustion engine 14 with the second electric prime mover 18 is possible, wherein an inertial mass or an inertia torque of the second electric prime mover 18 is preferably utilized for starting the internal combustion engine 14.

It is understood that the mirror imaging or the arrangement of the gear steps of the hybrid transmission 20 described with reference to FIG. 4 is also applicable for the example embodiments from FIGS. 5 and 6.

The invention was comprehensively described and explained with reference to the drawings and the description. The description and the explanation are to be understood as an example and are not to be understood as limiting. The invention is not limited to the disclosed embodiments. Other embodiments or variations result for a person skilled in the art within the scope of the utilization of the present invention and within the scope of a precise analysis of the drawings, the disclosure, and the following claims.

In the claims, the words “comprise” and “comprising” do not rule out the presence of further elements or steps. The indefinite article “a” does not rule out the presence of a plurality. A single element or a single unit can carry out the functions of several of the units mentioned in the claims. The mere mention of a few measures in multiple various dependent claims is not to be understood to mean that a combination of these measures cannot also be advantageously utilized.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 motor vehicle
12 motor vehicle drive train
14 internal combustion engine
16 first electric prime mover
18 second electric prime mover
20 hybrid transmission
22 energy accumulator
24 first transmission input shaft
26 second transmission input shaft
28 countershaft
30 fixed gear
32 fixed gear
34 drive output
36 gear shift matrix
K0 internal combustion engine clutch
K3 shift element
A shift element
B shift element
C shift element
D shift element
E shift element
A1-A5 transmission axes

1-15: (canceled)

16. A hybrid transmission (20) for a motor vehicle drive train (12) with an internal combustion engine (14), a first electric prime mover (16), and a second electric prime mover (18), the hybrid transmission (20) comprising:
a first transmission input shaft (24) for a first sub-transmission that is coaxially drivingly connectable to the internal combustion engine and/or drivingly connectable to the second electric prime mover in an axially parallel manner;
a second transmission input shaft (26) for a second sub-transmission that is drivingly connectable to the first electric prime mover in an axially parallel manner;
a countershaft (28);
a plurality of idler gears and fixed gears arranged in multiple gear set planes for forming a plurality of gear steps; and
a plurality of shift elements (A-E) for engaging the plurality of gear steps,
wherein all even gear steps of the plurality of gear steps are associated with one of the first and second sub-transmissions, and all odd gear steps of the plurality of gear steps are associated with the other of the first and second sub-transmissions.

17. The hybrid transmission (20) of claim 16, further comprising a connecting clutch configured for drivingly connecting the first sub-transmission and the second sub-transmission.

18. The hybrid transmission (20) of claim 16, further comprising an internal combustion engine clutch (K0) configured for drivingly connecting the internal combustion engine (14) to the first transmission input shaft (24).

19. The hybrid transmission (20) of claim 18, wherein the internal combustion engine clutch (K0) is a friction clutch or a form-locking shift element.

20. The hybrid transmission (20) of claim 16, wherein at least two of the plurality of shift elements (A-E, K3) are configured as a double shift element (AE, DB, CK3) actuatable by a double-acting actuator.

21. The hybrid transmission (20) of claim 16, wherein
the first transmission input shaft (24) and the second transmission input shaft (26) are arranged coaxially to each other; and
one of the first and second transmission input shafts is a hollow shaft that at least partially encompasses the other of the first and second transmission input shafts.

22. The hybrid transmission (20) of claim 16, wherein, one or both of:
a gear-forming fixed gear (32) of the first sub-transmission is configured to be drivingly operatively connected to the second electric prime mover (18); and
a gear-forming fixed gear (30) of the second sub-transmission is configured to be drivingly operatively connected to the first electric prime mover (16).

23. The hybrid transmission (20) of claim 22, wherein:
the gear-forming fixed gear (32) of the first sub-transmission forms the highest gear step of the first sub-transmission; and
the gear-forming fixed gear (30) of the second sub-transmission forms the highest gear step of the second sub-transmission.

24. The hybrid transmission (20) of claim 16, wherein a gear-forming fixed gear (30, 32) arranged at a first axial end of the hybrid transmission is configured to be drivingly connected to one or both of the first electric prime mover (16) and the second electric prime mover (18).

25. The hybrid transmission (20) of claim 24, wherein a gear-forming fixed gear (30, 32) arranged at a second axial end of the hybrid transmission opposite the first axial end is configured to be drivingly connected to one or both of the first electric prime mover (16) and the second electric prime mover (18).

26. A motor vehicle drive train (12) for a motor vehicle (10), comprising:
the hybrid transmission (20) of claim 16;
an internal combustion engine (14) connectable to the first transmission input shaft (24);
a first electric prime mover (16) connectable to the second transmission input shaft (26); and
a second electric prime mover (18) connectable to the first transmission input shaft.

27. The motor vehicle drive train (12) of claim 26, wherein one or both of the first electric prime mover (16) and the second electric prime mover (16, 18) is actuatable as one or more of:
a starter generator for starting the internal combustion engine (14);
a charging generator for charging an energy accumulator (22); and
a generator for supplying the first or second electric prime mover in a serial traveling mode.

28. The motor vehicle drive train (12) of claim 26, wherein
one or both of the second electric prime mover (18) and the internal combustion engine (14) is operable to provide a supporting force during gear changes of the first electric prime mover (16); and
the first electric prime mover is operable to provide as a supporting force during gear changes of one or both of the second electric prime mover and the internal combustion engine.

29. The motor vehicle drive train (12) of claim 26, wherein one or both of the first electric prime mover (16) and the second electric prime mover (18) is arranged axially parallel to one or both of the first transmission input shaft (24) and the second transmission input shaft (26).

30. A motor vehicle (10), comprising:
the motor vehicle drive train (12) of claim 26; and
an energy accumulator (22) for storing energy for supplying one or both of the first electric prime mover (16) and the second electric prime mover (18).
